(19) United States
(12) Patent Application Publication
(10) Pub. No.: US 2013/0026240 A1
(43) Pub. Date: Jan. 31, 2013

(54) TWO-DIMENSIONAL CODE, CODE GENERATION SYSTEM, PROGRAM, AND PRINTED MEDIUM

(71) Applicants: Manabu Hagiwara, Chiyoda-ku (JP); Nuttapong Attrapadung, Chiyoda-ku (JP); Akira Otsuka, Chiyoda-ku (JP); Hajime Watanabe, Chiyoda-ku (JP); Takashi Shinonaga, Chiyoda-ku (JP)

(72) Inventors: Manabu Hagiwara, Chiyoda-ku (JP); Nuttapong Attrapadung, Chiyoda-ku (JP); Akira Otsuka, Chiyoda-ku (JP); Hajime Watanabe, Chiyoda-ku (JP); Takashi Shinonaga, Chiyoda-ku (JP)

(21) Appl. No.: 13/522,262

(22) PCT Filed: Jan. 13, 2011
(86) PCT No.: PCT/JP2011/050386

§ 371 Date: Aug. 10, 2012

(30) Foreign Application Priority Data
Jan. 18, 2010 (JP) 2010-008522
Jan. 18, 2010 (JP) 2010-008525

(51) Int. Cl. G06K 19/06

(52) U.S. Cl. 235/494

(57) ABSTRACT

Provided is a two-dimensional code structured in such a way that the identification function for each of multiple components constituting the two-dimensional code, which have been concatenated and encoded in the form of structured append, has been enhanced. In a set of multiple two-dimensional codes that have been encoded in the form of structured append, wherein the two-dimensional code comprises an information area, an illustration area, and a parity area, each two-dimensional code which is a component of the set of multiple two-dimensional codes is a two-dimensional code having the same graphical illustration drawn in the illustration area.

### TECHNICAL FIELD

The present invention relates to a two-dimensional code concatenated in the form of structured append, and more specifically to a two-dimensional code structured in such a way that the identification function for each of multiple components constituting the two-dimensional code, which have been concatenated and encoded in the form of structured append, has been enhanced.

### BACKGROUND ART

Two-dimensional code encoded in the form of structured append is traditionally known as a way to encode one data set (hereinafter referred to as “original text”) into multiple two-dimensional codes (Patent Literature 1, Non-patent Literature 1).

Multiple two-dimensional codes generated by encoding one original text using the structured append function are referred to as “one set.” By reading one set of two-dimensional codes using a two-dimensional code decoder, or specifically by reading all two-dimensional codes in one set, the encoded original text can be restored.

Also, as described in Patent Literature 2, a two-dimensional code generator capable of generating a two-dimensional code which is structured in such a way that illustration can be expressed in some area of the two-dimensional code, has been proposed. By using this two-dimensional code generator, identification of each individual two-dimensional code can be enhanced.

### BACKGROUND ART LITERATURE

### Patent Literature

Patent Literature 1: Japanese Patent No. 2938338
Patent Literature 2: Japanese Patent Laid-open No. 2009-163720

### Non-Patent Literature

Non-patent Literature 1: JIS X0510, p. 48 to p. 49

### SUMMARY OF THE INVENTION

### Problems to be Solved by the Invention

To decode two-dimensional codes that have been concatenated and encoded in the form of structured append, a two-dimensional code decoder must be used to read all two-dimensional codes in one set.

However, general users have difficulty telling, just by looking, the difference between two-dimensional codes created using the structured append function and two-dimensional codes created without using such function, which gives rise to a problem that, if two-dimensional codes in one set are not consolidated but dispersed, it may be impossible to determine that these dispersed two-dimensional codes are components of one set.

In addition, although all two-dimensional codes in one set can be read using a two-dimensional code decoder to restore the encoded original text, decoding will not be performed correctly if components in one set are read multiple times.

For this reason, when multiple two-dimensional codes constitute one set of two-dimensional codes, it is traditionally indicated by providing supplemental explanation text around the applicable two-dimensional codes, but this requires extra space for writing text other than the two-dimensional codes.

Furthermore, it is difficult to easily tell, just by looking, whether or not a given two-dimensional code is a component of one set of two-dimensional codes created using the structured append function, and there is a problem that, when two-dimensional codes that are components of one set are mixed with two-dimensional codes that are components of a different set, picking out all components of any one set from the mixed two-dimensional codes is difficult. Since general users have difficulty telling, just by looking, that individual two-dimensional codes have been created in the form of structured append and constitute one set, an attempt to read the components of one set sometimes results in reading already read components again, in which case correct decoding is not possible. For this reason, positions of components already read must be memorized to prevent them from being read again, which complicates matters.

The present invention aims to solve the problems mentioned above, where the object of the present invention is to provide a two-dimensional code that allows for visual confirmation of whether or not multiple two-dimensional codes created using the structured append function constitute the same set, without providing supplemental explanation around the applicable two-dimensional codes. To be specific, the object of the present invention is to provide a two-dimensional code structured in such a way that the identification function for each of multiple components constituting the two-dimensional code, which have been concatenated and encoded in the form of structured append, has been enhanced.

### Means for Solving the Problems

To achieve the aforementioned object, one embodiment of the two-dimensional code proposed by the present invention is that, in a set of multiple two-dimensional codes that have been encoded in the form of structured append, wherein the two-dimensional code comprises an information area, an illustration area, and a parity area, each two-dimensional code which is a component of the set of multiple two-dimensional codes is a two-dimensional code having the same graphical illustration drawn in the illustration area.

Another embodiment of the two-dimensional code proposed by the present invention is that, in a set of multiple two-dimensional codes that have been encoded in the form of structured append, wherein the two-dimensional code comprises an information area, an illustration area, and a parity area, each two-dimensional code which is a component of the set of multiple two-dimensional codes is a two-dimensional code having a graphical illustration of strong association drawn in the illustration area.

To be specific, the two-dimensional code proposed by the present invention is produced in such a way that, in a two-dimensional code set comprising multiple two-dimensional codes that have been encoded in the form of structured append, each two-dimensional code which is a component of the set has an illustration area positioned after the terminator of data in an information area, up to the error correction word in a parity area, and the same graphical illustration is drawn in the illustration area.

In yet another embodiment, the two-dimensional code proposed by the present invention is produced in such a way that, in a two-dimensional code set comprising multiple two-dimensional codes that have been encoded in the form of structured append, each two-dimensional code which is a component of the set comprises an information area, an illustration area, and a parity area, and a graphical illustration of strong association is drawn in the illustration area.

Yet another embodiment is that, in a set of multiple two-dimensional codes that have been encoded in the form of structured append, wherein the two-dimensional code comprises an information area, an illustration area, and a parity area, each two-dimensional code which is a component of the set of multiple two-dimensional codes is a two-dimensional code having a graphical illustration depicting a different symbol drawn in the illustration area.

In yet another embodiment of the two-dimensional code proposed by the present invention is that, in a two-dimensional code constituting a set of multiple two-dimensional codes that have been encoded in the form of structured append, wherein the two-dimensional code comprises an information area, an illustration area, and a parity area, each two-dimensional code which is a component of the set of multiple two-dimensional codes is a two-dimensional code having a graphical illustration depicting a different character string drawn in the illustration area.

To be specific, the two-dimensional code is produced in such a way that, in a two-dimensional code set comprising multiple two-dimensional codes that have been encoded in the form of structured append, each two-dimensional code which is a component of the set has an illustration area positioned after the terminator of data in an information area, up to the error correction word in a parity area, and the same graphical illustration is drawn in the illustration area.

In yet another embodiment, the two-dimensional code proposed by the present invention is produced in such a way that, in a two-dimensional code set comprising multiple two-dimensional codes that have been encoded in the form of structured append, each two-dimensional code which is a component of the set comprises an information area, an illustration area, and a parity area, and a graphical illustration depicting a different character string is drawn in the illustration area.

In addition to the aforementioned embodiments, the two-dimensional code proposed by the present invention is produced in such a way that multiple two-dimensional codes are classified into two or more groups and one code is selected from each of all groups to be decoded in the form of structured append.

### Effects of the Invention

Having the aforementioned constitution, the present invention eliminates the problem of multiple two-dimensional codes that have been encoded in the form of structured append not being identified easily as to whether or not they belong to the same set, even when they are printed separately on paper, but instead the present invention makes such identification easy. Even when two-dimensional codes that are components of one set are mixed with two-dimensional codes that are components of a different set, all components of any one set can be picked out with ease.

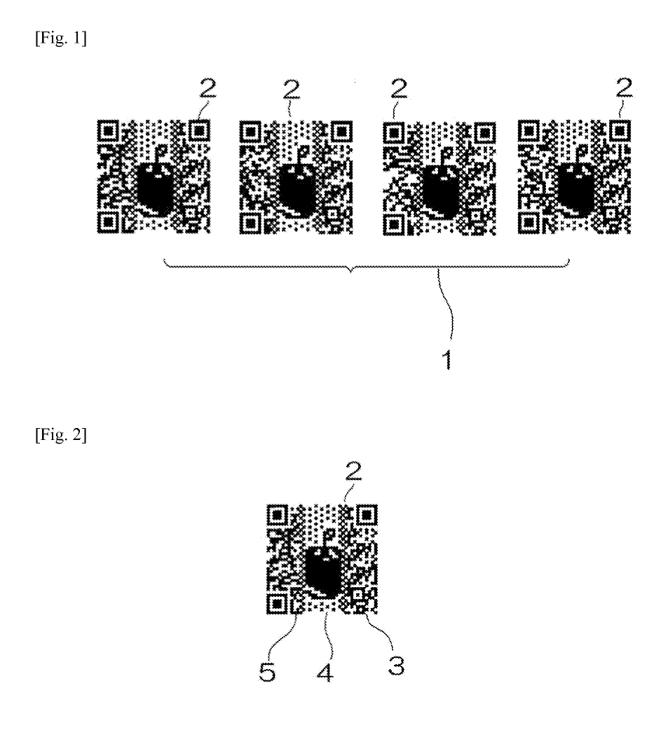

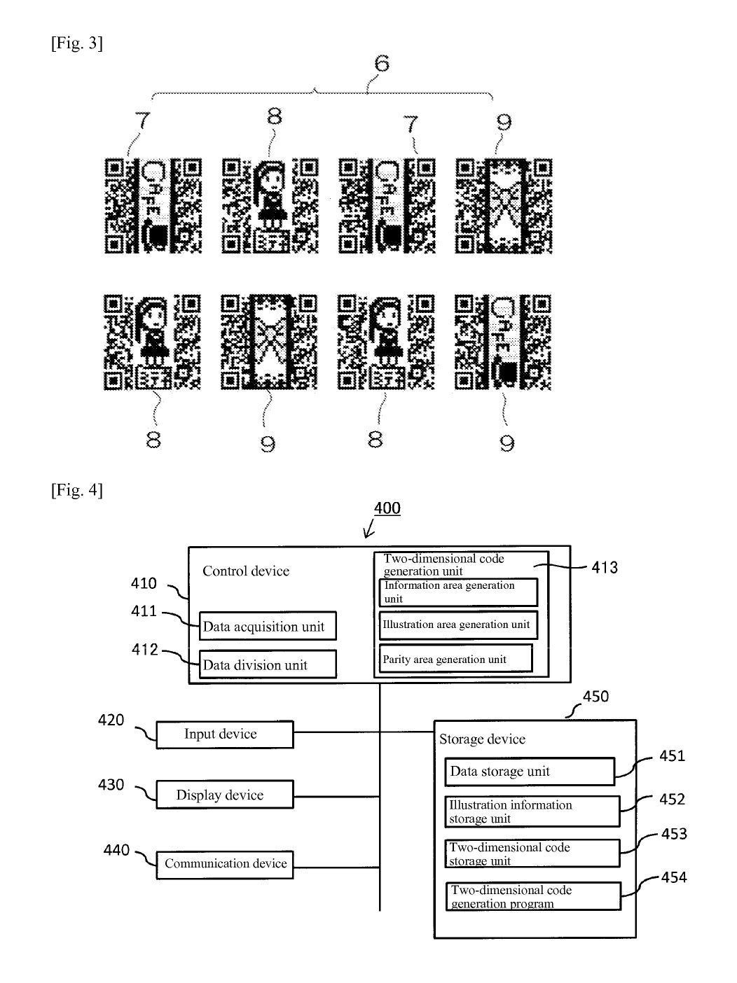

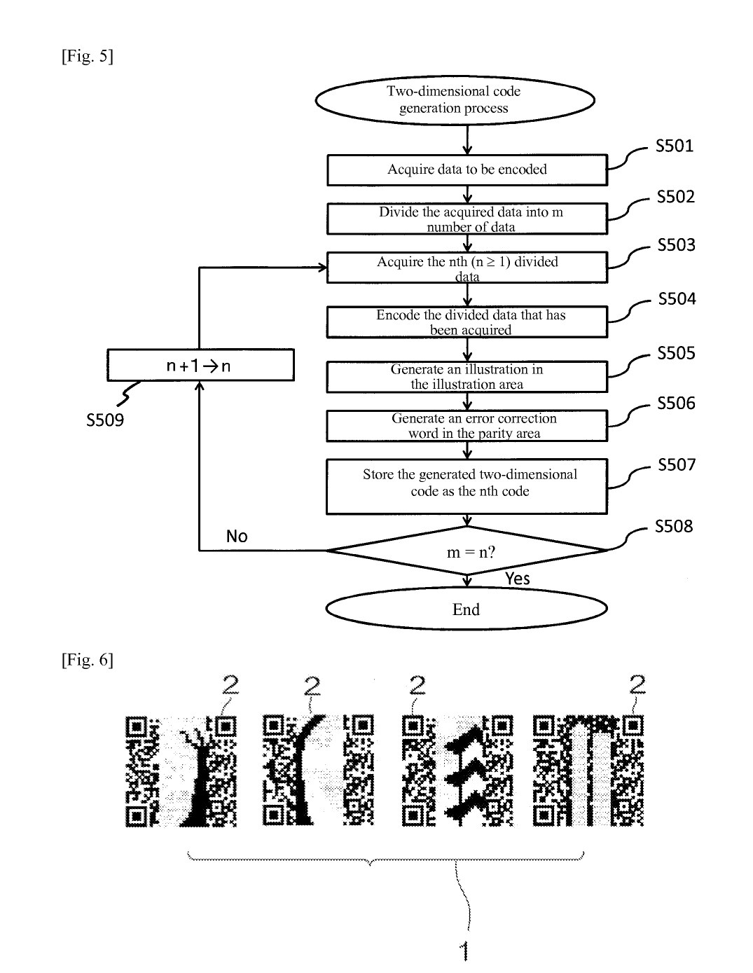

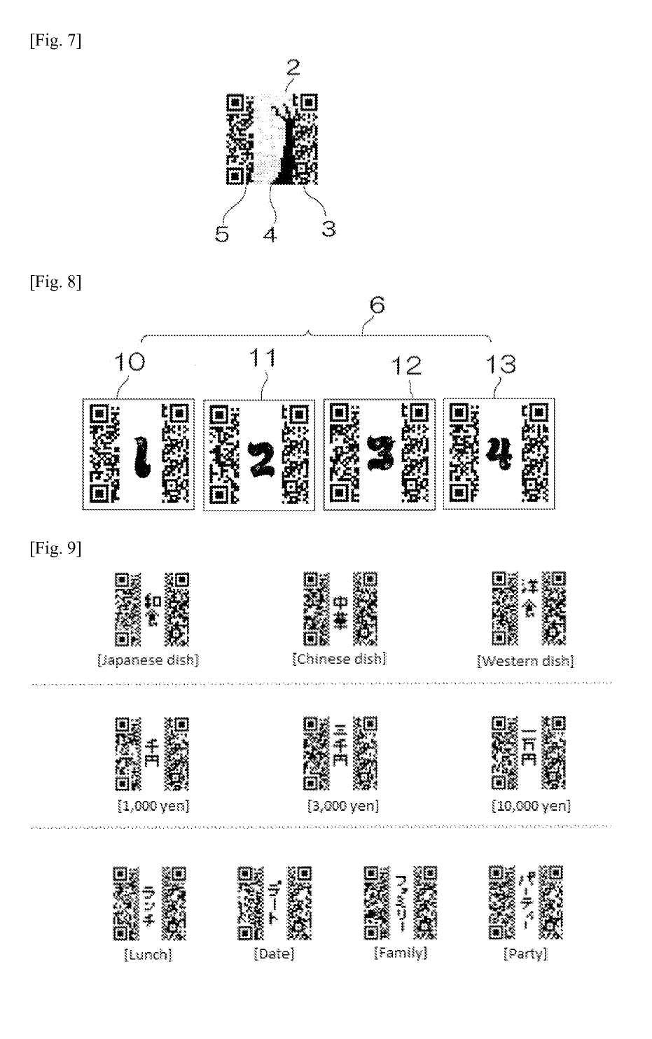

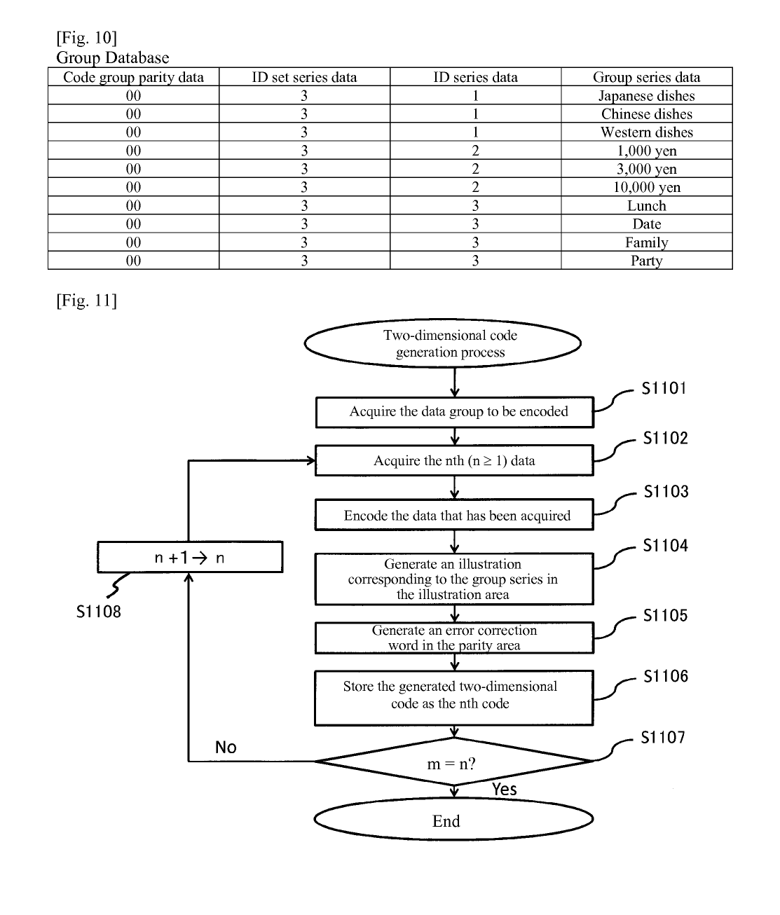

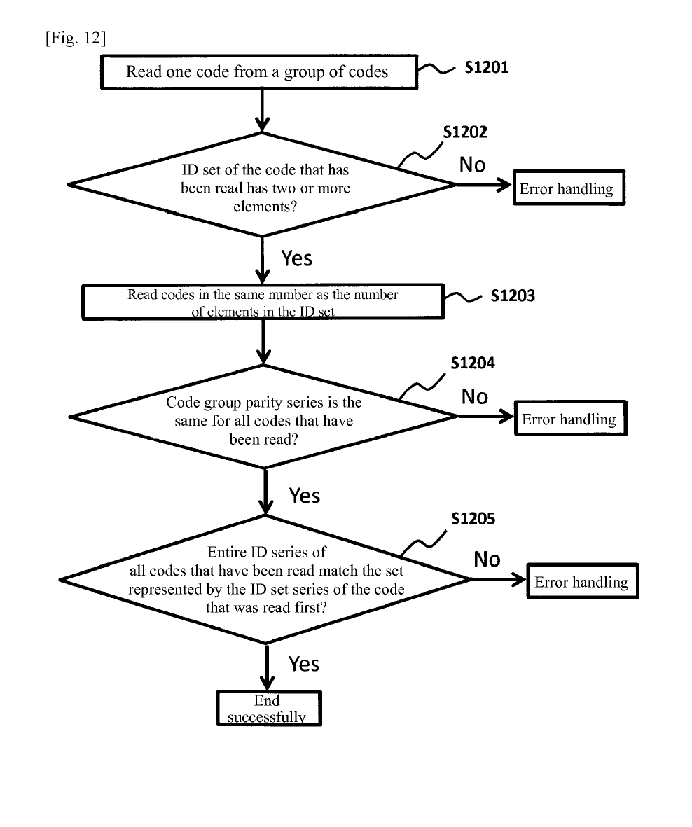

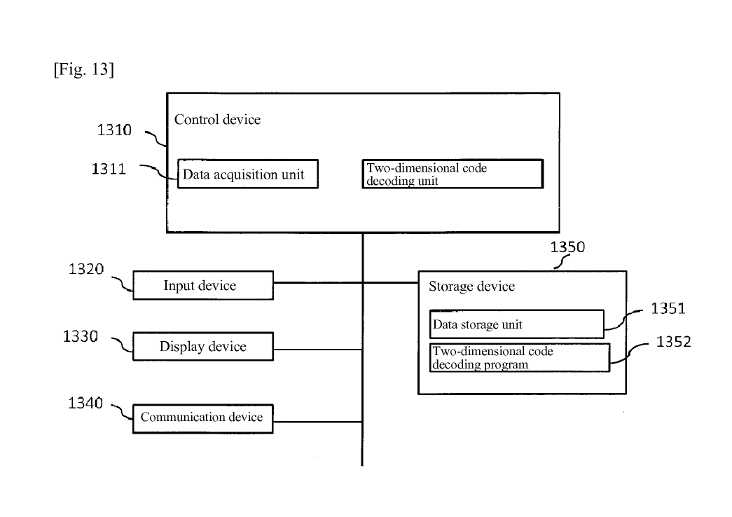

### BRIEF DESCRIPTION OF THE DRAWINGS

[FIG. 1] is a drawing showing an example of a set of two-dimensional codes that have been encoded in the form of structured append according to the first embodiment of the present invention.

[FIG. 2] is a drawing explaining the structure of one two-dimensional code which is a component of the set of two-dimensional codes that have been encoded in the form of structured append according to the first embodiment of the present invention.

[FIG. 3] is a drawing showing an example of mixed sets of two-dimensional codes that have been encoded in the form of structured append according to the first embodiment of the present invention.

[FIG. 4] is an example of a two-dimensional code generation system that generates two-dimensional codes conforming to the present invention.

[FIG. 5] is a flowchart of a two-dimensional code generation process according to the first embodiment of the present invention.

[FIG. 6] shows an example of a set of two-dimensional codes that have been encoded in the form of structured append according to the second embodiment of the present invention.

[FIG. 7] explains the structure of one two-dimensional code which is a component of the set of two-dimensional codes that have been encoded in the form of structured append according to the second embodiment of the present invention.

[FIG. 8] shows another example of a set of two-dimensional codes that have been encoded in the form of structured append according to the second embodiment of the present invention.

[FIG. 9] shows an example of a set of two-dimensional codes that have been encoded in the form of structured append according to the third embodiment of the present invention.

[FIG. 10] shows an example of a database stored in a data storage unit according to the third embodiment of the present invention.

[FIG. 11] is a flowchart of a two-dimensional code generation process according to the third embodiment of the present invention.

[FIG. 12] is a flowchart of a code reading method for two-dimensional code group judgment according to the third embodiment of the present invention.

[FIG. 13] shows an example of a two-dimensional code decoder conforming to the present invention.

### MODE FOR CARRYING OUT THE INVENTION

### First Embodiment

A mode for carrying out the two-dimensional code in the first embodiment of the present invention is explained below by referring to drawings. FIG. 1 is a drawing showing an example of a set of two-dimensional codes that have been encoded in the form of structured append according to the first embodiment of the present invention, while FIG. 2 is a drawing explaining the structure of one two-dimensional code which is a component of the set of two-dimensional codes that have been encoded in the form of structured append according to the first embodiment of the present invention. These figures are referred to in the following explanation.

As shown in FIG. 1, a set of two-dimensional codes that have been encoded in the form of structured append according to the first embodiment of the present invention is such that one data set is divided into multiple parts and encoded as multiple two-dimensional codes, where a common graphical illustration is placed in the two-dimensional codes to expressly indicate that they belong to one set. The set of two-dimensional codes that have been encoded in the form of structured append in FIG. 1 consists of four two-dimensional codes and, as explained later, an illustration depicting a part of an “apple” is placed commonly in their illustration areas. This two-dimensional code structure expressly indicates that these two-dimensional codes constitute one set.

As shown in FIG. 2, this two-dimensional code structure is based on a two-dimensional code 2 comprising an information area 3, an illustration area 4 and a parity area 5. As shown in FIG. 1, multiple two-dimensional codes 2 of this structure are encoded in the form of structured append to provide a set of multiple two-dimensional codes 1.

FIG. 3 shows an example of mixed sets of two-dimensional codes that have been encoded in the form of structured append. Two-dimensional codes 7, 8, 9 that have been encoded in the form of structured append constitute two-dimensional code sets, respectively, under the present invention, so even if they are mixed together, the set to which each two-dimensional code belongs can be clearly identified. FIG. 3 shows an example of three sets of two-dimensional codes 6 that have been encoded in the form of structured append, including a set 7 having a picture of coffee in the illustration area, a set 8 having a picture of doll in the illustration area, and a set 9 having a picture of ribbon in the illustration area.

As mentioned earlier, the two-dimensional code 2 comprises the information area 3, illustration area 4 and parity area 5. The two-dimensional code 2 is encoded using, for example, the two-dimensional code generator explained in Patent Literature 2.

FIG. 4 shows an example of a two-dimensional code generation system conforming to the present invention. A two-dimensional code generation system 400 can be implemented on a general personal computer and has a control device 410 comprising a CPU, microprocessor, IC memory or other computing device, an input device 420 such as a keyboard, mouse, etc., a display device 430 comprising a display, etc., a communication device 440 for sending/receiving data to/from an external device, and a storage device 450 comprising an IC memory, magneto-optical disk or other information storage medium. It should be noted, however, that the foregoing configuration is only an example and any of these components may be omitted.

The control device 410 controls the operation of the two-dimensional code generation system by performing various computational processes based on instructions from the input device 420, etc. For example, it displays inputs on the display device 430 based on input signals from the input device 420, or controls data received externally via the communication device 440 to be stored in the storage device 450, or reads data from the storage device 450 and controls it to be sent externally via the communication device 440. It also reads and executes a program stored in the storage device 450 to perform computations.

The control device 410 comprises, for example, a CPU (central processing unit), VDP (video display processor) or other processor, ASIC, IC memory, etc., and reads a two-dimensional code generation program 454 stored in the storage device 450, while reading from a data storage unit 451 data to be encoded that has been stored in the storage device 450 via a data acquisition unit 411 and then dividing the data at a data division unit 412, and reading illustrations from an illustration information storage unit 453 at the data acquisition unit 411, after which the two-dimensional code program 454 is executed at a two-dimensional code generation unit 413 to generate two-dimensional codes. The two-dimensional code generation unit 413 has an information area generation unit that generates the information area of the two-dimensional code, an illustration area generation unit that draws an illustration in the illustration area which is filled with padding bits, and a parity area generation unit that generates the parity area.

The input device 420 comprises the mouse, keyboard, buttons and other elements of an image generation device, and generates input signals according to the user's operations of the two-dimensional code generator and inputs them to the control device 410.

The display device 430 comprises a liquid crystal display device, for example, and displays and outputs images, such as screens used for specifying data to be encoded and illustrations, according to image signals output from the control device 410.

The communication device 440 comprises an interface for sending/receiving data to/from an external device, such as a USB connector, LAN connector, wireless LAN module, etc. Through the communication device 440, data can be received from an external device and stored in the storage device 450, or two-dimensional codes generated by the two-dimensional code generation unit of the control device 410 can be sent.

The storage device 450 comprises, for example, a ROM (read only memory), flash memory or other storage device, or magneto-optical disk, USB memory or other removable external storage device, and stores a program, data, etc., needed to operate an image processing device or temporarily stores data needed to display and generate images.

The storage device 450 has a data storage unit 451 where data to be encoded in two-dimensional code generation is stored, an illustration information storage unit 452 where illustration information is stored, a two-dimensional code storage unit 453 where generated two-dimensional codes are stored, and a two-dimensional code generation program 454.

A two-dimensional code which is the Nth component of a set of M components of two-dimensional codes is created according to JIS X 0510 as follows. The specific method is explained below.
(1) All symbols except for the timing pattern and data code word are created according to JIS X 0510. The timing pattern is an arbitrary bit sequence. For the error correction level, mask and version, values that have been set beforehand are used. For example, L is used for the error correction level, 3 for the mask, and 5 for the version. Other values may be used.
(2) Data to be encoded is divided into a desired number of data components, or M components of data in this case, beforehand.

The data code word is constituted as follows.
(3) The data code starts with a structured append mode indicator, followed by a symbol sequence indicator for an Nth component, parity data of the data to be encoded, mode indicator representing a numeric mode, alphanumeric mode, 8-bit byte mode or kanji mode, data indicating the number of characters according to JIS X 0510, data expressing the divided data of the Nth component by a sequence of 0's or 1's according to the aforementioned mode indicator and in conformance with JIS X 0510, terminator, and arbitrary padding bits.

The area filled with these padding bits, or specifically area after the terminator of data in the information area, up to the error correction word in the parity area, is defined as the illustration area 4 and the same graphical illustration is drawn in this illustration area 4.

FIG. 5 is a flowchart that assumes the aforementioned two-dimensional code generation method is applied to the two-dimensional code generation system 400. First, when the two-dimensional code program 454 is started, the data acquisition unit 411 of the control device 420 acquires the data to be encoded as two-dimensional code from the data storage unit 451 (S501). The data division unit 412 divides the acquired data into M components of data (S502). The divided data is encoded as M components of two-dimensional codes designated from 1st to Mth. For generating a two-dimensional code constituting an Nth component, the divided data of the Nth component to be encoded is acquired (S503). Then, data is generated by encoding the divided data of the Nth component that has been acquired, with a sequence consisting of 0's and 1's, and also a structured append mode indicator indicating that the data is generated from the M components of data constituting the information area, a symbol sequence indicator indicating that the data is of the Nth component, a mode indicator indicating a numeric mode, alphanumeric mode, 8-bit byte mode or kanji mode, and data indicating the number of characters according to JIS X 0510, thereby generating data of the information area by the information area generation unit (S504). Next, the illustration area generation unit acquires the graphical illustration to be drawn in the illustration area from the illustration information storage unit 453 and draws the illustration (S505). Further, the parity area generation unit generates an error correction word according to the data to be encoded and embeds it in the parity area (S506). The generated two-dimensional code is stored in the two-dimensional code storage unit 453 as the two-dimensional code of the Nth component (S507). In the two-dimensional code generation process, two-dimensional codes are generated sequentially for N incremented by one at a time until N becomes equal to M (S508, S509). While this flowchart is configured in such a way that data is generated in the order of information area, illustration area, and parity area, the order is not limited to the foregoing as long as two-dimensional codes each comprising the information area, illustration area, and parity area are generated.

Once two-dimensional codes having the aforementioned structure are generated and these two-dimensional codes are printed and used on printed media, use of the same graphical illustration in the illustration area 4 of each two-dimensional code 2 allows for identification of whether or not each two-dimensional code belongs to the same two-dimensional code set 1, without providing any supplementary explanation text, regardless of whether individual two-dimensional codes are displayed on the same medium or multiple media. In addition to the above embodiment, the same effect can be achieved by using a graphical illustration of strong association in the illustration area 4.

When two-dimensional codes having the aforementioned structure are decoded, reading one of multiple two-dimensional codes results in an identification that it belongs to a given two-dimensional code set constituted by multiple two-dimensional codes, due to the structured append mode indicator, which means that decoding will not complete until all two-dimensional codes constituting the set are read.

### Second Embodiment

A mode for carrying out the two-dimensional code in the second embodiment of the present invention is explained below by referring to drawings. FIG. 6 is a drawing showing an example of a set of two-dimensional codes that have been encoded in the form of structured append according to the present invention, while FIG. 7 is a drawing explaining the structure of one two-dimensional code which is a component of the set of two-dimensional codes that have been encoded in the form of structured append according to the present invention. These figures are referred to in the following explanation.

As shown in FIG. 6, the set of two-dimensional codes that have been encoded in the form of structured append according to the present invention is based on encoding of one data set into multiple two-dimensional codes, where a graphical illustration depicting a different symbol is placed in each two-dimensional code to expressly indicate that it belongs to the set and also to easily identify whether or not the two-dimensional code has already been input. The set of two-dimensional codes that have been encoded in the form of structured append in FIG. 6 consists of four two-dimensional codes, each having a different symbol in the illustration area, such as graphical illustration depicting a symbol of “right side of a large tree,” graphical illustration depicting a symbol of “left side of a large tree,” graphical illustration depicting a symbol of “roof of a 3-story building,” and graphical illustration depicting a symbol of “high-rise building,” as explained later. This way, when the multiple two-dimensional codes that have been encoded in the form of structured append are decoded using a two-dimensional code decoder, whether or not each two-dimensional code has already been input can be identified with ease.

This two-dimensional code structure provides a two-dimensional code 2 comprising an information area 3, an illustration area 4 and a parity area 5, as shown in FIG. 7, as well as a two-dimensional code set 1 comprising multiple two-dimensional codes 2 of this structure that have been encoded in the form of structured append, as shown in FIG. 6.

FIG. 8 shows another example of multiple sets of two-dimensional codes that have been encoded in the form of structured append. Two-dimensional codes 10, 11, 12, 13 that have been encoded in the form of structured append constitute two-dimensional code sets according to the present invention, where each two-dimensional code has a graphical illustration depicting an associated but different symbol and can therefore be identified. As a result, whether or not each two-dimensional code has already been input can be identified with ease at the time of decoding. FIG. 8 shows an example of four sets of two-dimensional codes 6 that have been encoded in the form of structured append, each having a graphical illustration depicting a different character string in the illustration area.

A two-dimensional code which is the Nth component of a set of M components of two-dimensional codes is created according to JIS X 0510 as follows. The specific method is explained below.
(1) All symbols except for the timing pattern and data code word are created according to JIS X 0510. The timing pattern is an arbitrary bit sequence. For the error correction level, mask and version, values that have been set beforehand are used. For example, L is used for the error correction level, 3 for the mask, and 5 for the version. Other values may be used.
(2) Data to be encoded is divided into a desired number of components of data, or M components data in this case, beforehand.

The data code is constituted as follows.

(3) The data code starts with a structured append mode indicator, followed by a symbol sequence indicator for the Nth data component, parity data of the data to be encoded, mode indicator representing a numeric mode, alphanumeric mode, 8-bit byte mode or kanji mode, data indicating the number of characters according to JIS X 0510, data expressing the Nth component of data by a sequence of 0's or 1's according to the aforementioned mode indicator and in conformance with JIS X 0510, terminator, and arbitrary padding bits.

The area filled with these padding bits, or specifically area after the terminator of data in the information area, up to the error correction word in the parity area, is defined as the illustration area 4 and a graphical illustration depicting a different symbol is drawn in this illustration area 4.

Two-dimensional codes may also be structured in such a way that a graphical illustration depicting different character strings is drawn in the illustration area 4.

It should be noted that the two-dimensional code generation process in this embodiment can be implemented based on the configuration of the two-dimensional code generation system 400 in the first embodiment, and that the same goes with the two-dimensional code generation process.

In this embodiment, however, in each two-dimensional code a graphical illustration depicting a different character string or symbol is drawn, and consequently the illustration information storage unit 452 stores information for multiple illustrations. According to the example of FIG. 8, illustration information for “1,” “2,” “3” and “4” are stored in the illustration information storage unit 452. Then, when the divided data is encoded as two-dimensional code, illustration information to be embedded is specified sequentially and then read sequentially in the illustration information generation process in step 505 to generate two-dimensional codes.

When two-dimensional codes generated according to the aforementioned structure are used, and a graphical illustration depicting a different symbol is used in the illustration area 4 of each two-dimensional code 2, whether or not each two-dimensional code belongs to the same two-dimensional code set 1 can be identified, without providing supplementary explanatory text, regardless of whether the two-dimensional codes in this condition are displayed on the same medium or multiple media. In addition to the above embodiment, the same effect can be achieved by using graphical illustrations depicting strongly associated but different symbols in the illustration area 4, as shown in FIG. 8.

### Third Embodiment

A mode for carrying out the two-dimensional code in the third embodiment of the present invention is explained below by referring to drawings. FIG. 9 is a drawing showing an example of a set of two-dimensional codes that have been encoded in the form of structured append according to the third embodiment of the present invention. The set of two-dimensional codes that have been encoded in the form of structured append in FIG. 9 consist of ten two-dimensional codes. The two-dimensional codes in this embodiment are different from those in the first and second embodiments in that not all ten two-dimensional codes are concatenated as they are encoded in the form of structured append. In this embodiment, the ten two-dimensional codes form one group, but two-dimensional codes in the top, middle and bottom rows also form subgroups, each of a different category, and by selecting any one two-dimensional code from each of all subgroups, one text can be decoded. In other words, while the three subgroups are concatenated in the form of structured append, the data to be displayed when being encoded varies depending on which of the two-dimensional codes belonging to each subgroup is selected.

In other words, the two-dimensional codes in the top row showing illustrations corresponding to the Japanese words for “Japanese,” “Chinese” and “Western” belong to the same subgroup of meal genre (such as Group A), two-dimensional codes in the middle row showing illustrations corresponding to the Japanese words for “1,000 yen,” “3,000 yen” and “10,000 yen” form a different subgroup of price (such as Group B), and two-dimensional codes in the bottom row showing illustrations corresponding to the Japanese words for “Lunch,” “Date,” “Family” and “Party” form yet another subgroup of scene (such as Group C). In addition, printed media on which these two-dimensional codes are printed are provided with the category name “genre,” “price” or “scene” given to each group.

Then, decoding cannot be completed unless one two-dimensional code is selected from all groups of A, B and C. For example, reading the two-dimensional codes “Japanese,” “1,000 yen” and “Lunch” sequentially results in the data “Japanese, 1,000 yen, lunch” being decoded. Or, Internet addresses or URL's providing information of Japanese restaurants offering lunch menus at around 1,000 yen or specific information of such restaurants may be displayed. It suffices to read one two-dimensional code from each of all subgroups, and the order of selected subgroups does not matter. Two-dimensional code selection need not start from Group A.

If a selection is not made from all three groups, however, such as when three two-dimensional codes are selected including two from Group A and one from Group B, data will not be decoded and an error will occur.

FIG. 10 is a table showing an example of a database stored in a data storage unit according to the third embodiment of the present invention. The two-dimensional code generation system that generates two-dimensional codes according to this embodiment has the same configuration as the system in the first embodiment, but the database such as the one shown in FIG. 10 is stored in the data storage unit 451.

Shown in the example of FIG. 10 is a database used for generating groups for two-dimensional codes as shown in FIG. 9. Data to be encoded with respective two-dimensional codes is stored as a group series data. The code group parity data is a code indicating the same group, and the code “00” is assigned in this example. In the two-dimensional code decoding process, the code group parity data is referenced to check if each two-dimensional code belongs to the same group. The ID set series data indicates the number of subgroups in a group. In this example, there are three subgroups of A, B and C, so this data is “3,” indicating the set (1, 2, 3). The ID set series data corresponds to the structured append mode indicator in the first and second embodiments. In the two-dimensional code decoding process, the code indicated by this ID set series data is referenced when the first two-dimensional code is read, to determine how many two-dimensional codes are structurally appended. The ID series data is a code indicating a subgroup, and the same ID series data is given to data belonging to the same subgroup. The ID series data corresponds to the symbol sequence indicator in the first and second embodiments. When ID series data of all subgroups are put together, it matches the set represented by the ID set series.

FIG. 11 is a flowchart of a two-dimensional code generation process according to the third embodiment of the present invention. First, when the two-dimensional code program 454 is started, the data acquisition unit 411 of the control device 420 acquires a group of data to be encoded as two-dimensional code from the data storage unit 451 (S1101). Since the number of two-dimensional codes to be generated can be calculated from the number of those having the identical code of the code group parity data stored in the storage unit, data stored in the group series data is encoded as M components of two-dimensional codes designated from 1st to Mth. For generating a two-dimensional code constituting an Nth component, the group series data of the Nth component to be encoded is acquired (S1102). Then, data is generated by encoding the group series data of the Nth component that has been acquired, with a sequence consisting of 0's and 1's, and also a code group parity data, an ID set series data, an ID series data, a mode indicator indicating a numeric mode, alphanumeric mode, 8-bit byte mode or kanji mode, and data indicating the number of characters according to JIS X 0510, are attached, thereby generating data of the information area by the information area generation unit (S1103). Next, the illustration area generation unit acquires the graphical illustration to be drawn in the illustration area from the illustration information storage unit 453 and draws the illustration (S1104). Here, illustration information corresponding to each group series data may be stored separately. In addition, illustration information may be character strings or illustrations, corresponding to the contents of group series data. Further, the parity area generation unit generates an error correction word according to the data to be encoded and embeds it in the parity area (S1105). In the two-dimensional code generation process, two-dimensional codes are generated sequentially for N incremented by one at a time until N becomes equal to M (S1106, S1107). While this flowchart is configured in such a way that data is generated in the order of information area, illustration area, and parity area, the order is not limited to the foregoing as long as two-dimensional codes each comprising the information area, illustration area, and parity area are generated.

FIG. 12 is a flowchart of a code reading method for two-dimensional code group judgment according to the third embodiment of the present invention, while FIG. 13 shows an example of two-dimensional code decoder. The decoder, which decodes two-dimensional codes, has an input device 1320, a display device 1330, a communication device 1340, a storage device 1350 and a control device 1310, just like the two-dimensional code generation system in FIG. 4. A two-dimensional code reader is installed for the input device, and two-dimensional codes input from the input device are decoded by the control device 1310 using a two-dimensional code decoding program 1352 stored in the storage device.

One of a group of multiple two-dimensional codes is read (S1201). The ID set series data of the two-dimensional code that has been read is referenced to check if the ID set series data of the two-dimensional code has two or more elements in the ID set (S1202). To be specific, if the ID set series data is “1,” it means that the code comprises only one two-dimensional code instead of structurally appended two-dimensional codes, and accordingly an error generates in this flow. If the ID set series data is “3” (or “11” in binary code), for example, three elements (two-dimensional codes) are required and the program proceeds to the next step where the same number of codes as the number of elements indicated by the ID set series data are read using the reader (S1203). Then, whether the code group parity series data is the same for all codes that have been read is checked (S1204). This check is performed to see if all two-dimensional codes that have been read belong to the same group and if they all belong to the same group, the same code can be detected from all two-dimensional codes. Next, the ID series data of all codes that have been read are checked to see if they match the set represented by the ID set series of the two-dimensional code that was read first (S1205). This check reveals whether or not one two-dimensional code was read from each of all subgroups. To be specific, if the ID set series data is “3,” the set is (1, 2, 3), and therefore the ID series data extracted from the two-dimensional codes that have been read are collected to see if they match (1, 2, 3). If the result of this check is not a match, an error occurs and decoding cannot be performed. If the result of the check is a match, the multiple two-dimensional codes temporarily stored in the data storage unit 1351 of the storage device 1350 are put together and fed through the decoding process to obtain the original text data.

According to the third embodiment of the present invention, a two-dimensional code group whose combination is correct or wrong is determinable by a decoder can be constituted, meaning that a correct combination pattern of multiple two-dimensional codes can be constituted while preventing its decoding based on a wrong pattern. Also, multiple two-dimensional codes can be printed in subgroups beforehand on printed media, so that the user can select desired two-dimensional codes from the respective subgroups with ease. This way, decoding becomes possible based on any combination of data to generate two-dimensional codes having flexible structured appends.

The above explained the best modes for carrying out the present invention pertaining to structurally appended and encoded two-dimensional codes. It should be noted, however, that the present invention is not at all limited to the above patterns and it goes without saying that various other embodiments are available within the scope of technical items described in “What is claimed is” and that the present invention can also be applied to other codes.

### INDUSTRIAL FIELD OF APPLICATION

Having the aforementioned constitution, two-dimensional codes conforming to the present invention can be visually confirmed and they can also be applied as a countermeasure to phishing frauds where some two-dimensional codes are swapped.

### DESCRIPTION OF THE SYMBOLS

1 Two-dimensional code set

2 Two-dimensional code being a component of the set

3 Information area

4 Illustration area

5 Parity area

6 Two-dimensional code set based on structured append encoding

7 A set of two-dimensional codes having a picture of coffee in the illustration area

8 A set of two-dimensional codes having a picture of a doll in the illustration area

9 A set of two-dimensional codes having a picture of ribbon in the illustration area

10 Two-dimensional code having a different character string in the illustration area

11 Two-dimensional code having a different character string in the illustration area

12 Two-dimensional code having a different character string in the illustration area

13 Two-dimensional code having a different character string in the illustration area

1. A non-transitory, scannable two-dimensional code in a set of multiple two-dimensional codes encoded in a form of structured append constituted by an information area, an illustration area, and a parity area, said two-dimensional code being characterized in that each two-dimensional code which is a component of the set of multiple two-dimensional codes has a same graphical illustration drawn in the illustration area.

2. A non-transitory, scannable two-dimensional code in a set of multiple two-dimensional codes encoded in a form of structured append constituted by an information area, an illustration area, and a parity area, said two-dimensional code being characterized in that each two-dimensional code which is a component of the set of multiple two-dimensional codes has a graphical illustration of strong association drawn in the illustration area.

3. A non-transitory, scannable two-dimensional code in a set of multiple two-dimensional codes encoded in a form of structured append constituted by an information area, an illustration area, and a parity area, said two-dimensional code being characterized in that each two-dimensional code which is a component of the set of multiple two-dimensional codes has drawn in the illustration area a graphical illustration depicting a different symbol or character string.

4. The two-dimensional code according to claim 3, wherein the multiple two-dimensional codes are classified into two or more groups and can be decoded in a form of structured append by selecting one code from each of all groups.

5. A code generation system, characterized by comprising:
a data storage means for storing data to be encoded;
an illustration information storage means for storing illustration information to be drawn in each code;
data division means for dividing the data into two or more data components; and
a code generation means for generating a code by encoding each divided data component and drawing illustration information;
wherein the code generation means generates multiple structurally appended codes by generating codes until all divided data components are encoded.

6. A non-transitory program for generating codes stored in a computer-readable medium, characterized by comprising:
dividing data into two or more data components;
acquiring illustration information to be drawn in each code; and
encoding each divided data component and drawing illustration information to generate a code;
wherein, when codes are generated, the program causes a computer to keep generating codes until all divided data components are encoded so as to generate multiple structurally appended codes.

7. The program according to claim 6, characterized in that, when codes are generated, the program causes a computer to generate codes in such a way that the same illustration information is drawn in all codes.

8. The program according to claim 6, characterized in that, when codes are generated, the program causes a computer to generate codes in such a way that different illustration information is drawn in each codes.

9. The program according to claim 6, characterized in that, when codes are generated, the program causes a computer to generate codes in such a way that illustration information of strong association is drawn in each code.

10. The program according to claim 6, characterized in that the data includes ID set series data indicating the number of structured appends and ID series data indicating the order of data, and the data is encoded together with the ID set series data and ID series data.

11. A non-transitory, scannable two-dimensional code characterized by being generated by a program according to claim 6.

12. A printed medium characterized by having a two-dimensional code according to claim 1 printed thereon.

13. A non-transitory, scannable two-dimensional code characterized by being generated by a program according to claim 7.

14. A non-transitory, scannable two-dimensional code characterized by being generated by a program according to claim 8.

15. A non-transitory, scannable two-dimensional code characterized by being generated by a program according to claim 9.

16. A non-transitory, scannable two-dimensional code characterized by being generated by a program according to claim 10.

17. A printed medium characterized by having a two-dimensional code according to claim 2 printed thereon.

18. A printed medium characterized by having a two-dimensional code according to claim 3 printed thereon.

19. A printed medium characterized by having a two-dimensional code according to claim 4 printed thereon.

20. A printed medium characterized by having a two-dimensional code according to claim 11 printed thereon.
